(19) United States
(12) Patent Application Publication
(10) Pub. No.: US 2026/0222211 A1
(43) Pub. Date: Jul. 30, 2026

(54) TERMINAL DEVICE, IDENTITY VERIFICATION ASSISTANCE METHOD, AND COMPUTER-READABLE STORAGE MEDIUM

(71) Applicant: NEC Corporation, Tokyo (JP)

(72) Inventors: Eisuke KAWAKAMI, Tokyo (JP); Yasunari TSUJI, Tokyo (JP)

(73) Assignee: NEC Corporation, Tokyo (JP)

(21) Appl. No.: 19/142,321

(22) PCT Filed: Jan. 10, 2023
(86) PCT No.: PCT/JP2023/000278

§ 371 Date: Jun. 23, 2025

(51) Int. Cl. H04L 9/32; H04L 9/08

(52) U.S. Cl. CPC H04L 9/3231; H04L 9/0825; H04L 9/3263

(57) ABSTRACT

A terminal device of an embodiment of the present disclosure comprises: a first acquisition means that measures the body or voice of a user when the user is to be authenticated, and acquires first biological information, which is biological information corresponding to the measurement result; a second acquisition means that acquires second biological information, which is biological information corresponding to the body or voice of a person and stored in an information storage medium, and an electronic certificate indicating the authenticity of the person; an authentication means for performing user authentication by comparison based on the first biological information and the second biological information; and a transmission means for transmitting the acquired electronic certificate and authentication result if the user has been authenticated.

### TECHNICAL FIELD

The present disclosure relates to a technique of supporting identity verification in a procedure via a network.

### BACKGROUND ART

Services that allow consumers to perform procedures online are generally provided in various business types such as finance, insurance, real estate, retail, infrastructure, and the like. A technique for performing identity verification in such a situation is disclosed.

PTLs 1 and 2 disclose a method of performing identity verification at a time of opening an account of a financial institution from a terminal owned by a user.

Specifically, the information processing device according to PTL 1 images the face of the user and a license of the user in the terminal.

Then, the information processing device compares the captured facial image of the user with the captured facial image of the license, and determines whether the action of the user corresponds to a predetermined action, thereby performing identity verification.

The identity verification system according to PTL 2 outputs a guide screen designating an arrangement position of an object to be captured together with an identity verification document. Then, the identity verification system compares an identity verification image including the identity verification document captured in accordance with the guide screen with a collation image, which is separately captured and includes a face of an owner of the identity verification document, thereby performing identity verification.

### CITATION LIST

### Patent Literature

PTL 1: WO 2020/022014 A 1

PTL 2: JP 2020-161191 A

### SUMMARY OF INVENTION

### Technical Problem

At a time of performing identity verification by face matching, a captured facial image of a user may be compared with a captured image of an official certificate attached with a facial portrait. At this time, the comparison may not be accurately carried out depending on a state of the surface of the official certificate, quality of the captured image, and the like. A third party other than the legitimate user may impersonate the legitimate user by using a forged identity verification document or the like.

The present disclosure has been conceived in view of the problems described above, and an object of the present disclosure is to provide a terminal device and the like capable of appropriately performing identity verification.

### Solution to Problem

A terminal device according to an aspect of the present disclosure includes a first acquisition means for measuring a body or voice of a user at when authenticating the user and acquiring first biological information, the first biological information being biological information according to a result of the measurement, a second acquisition means for acquiring second biological information and an electronic certificate indicating authenticity of a person, the second biological information being biological information relevant to a body or voice of the person, the second biological information and the electronic certificate being stored in an information storage medium, an authentication means for authenticating the user by comparison based on the first biological information and the second biological information, and a transmission means for transmitting the acquired electronic certificate and an authentication result when the user is authenticated.

An identity verification assistance method according to an aspect of the present disclosure includes, in a terminal operated by a user, measuring a body or voice of the user when authenticating the user and acquiring first biological information, the first biological information being biological information according to a result of the measurement, acquiring second biological information and an electronic certificate indicating authenticity of a person, the second biological information being biological information relevant to a body or voice of the person, the second biological information and the electronic certificate being stored in an information storage medium, authenticating the user by comparison based on the first biological information and the second biological information, and transmitting the acquired electronic certificate and an authentication result when the user is authenticated.

A computer-readable storage medium according to an aspect of the present disclosure stores a program for executing a process including, in a terminal operated by a user, measuring a body or voice of the user when authenticating the user and acquiring first biological information, the first biological information being biological information according to a result of the measurement, acquiring second biological information, and an electronic certificate indicating authenticity of a person, the second biological information being biological information relevant to a body or voice of the person, and an electronic certificate indicating authenticity of the person, the second biological information and the electronic certificate being stored in an information storage medium, authenticating the user by comparison based on the first biological information and the second biological information, and transmitting the acquired electronic certificate and an authentication result when the user is authenticated.

### Advantageous Effects of Invention

According to the present disclosure, identity verification may be appropriately performed.

### BRIEF DESCRIPTION OF DRAWINGS

FIG. 1 is a block diagram illustrating an exemplary functional configuration of a terminal device according to a first example embodiment of the present disclosure.

FIG. 2 is a flowchart for explaining exemplary operation of the terminal device according to the first example embodiment of the present disclosure.

FIG. 3 is a diagram schematically illustrating an exemplary configuration including an identity verification assistance system according to a second example embodiment of the present disclosure.

FIG. 4 is a block diagram illustrating an exemplary functional configuration of the identity verification assistance system according to the second example embodiment of the present disclosure.

FIG. 5 is a diagram illustrating an exemplary situation in which information is read from an information storage medium according to the second example embodiment of the present disclosure.

FIG. 6A is a flowchart for explaining first exemplary operation of a terminal device according to the second example embodiment of the present disclosure.

FIG. 6B is a flowchart for explaining second exemplary operation of the terminal device according to the second example embodiment of the present disclosure.

FIG. 7A is a flowchart for explaining first exemplary operation of a provider server according to the second example embodiment of the present disclosure.

FIG. 7B is a flowchart for explaining second exemplary operation of the provider server according to the second example embodiment of the present disclosure.

FIG. 8 is a block diagram illustrating an exemplary functional configuration of an identity verification assistance system according to a third example embodiment of the present disclosure.

FIG. 9 is a flowchart for explaining exemplary operation of a terminal device according to the third example embodiment of the present disclosure.

FIG. 10 is a block diagram illustrating an exemplary hardware configuration of a computer device that implements identity verification assistance systems according to the first, second, and third example embodiments of the present disclosure.

### EXAMPLE EMBODIMENT

Hereinafter, example embodiments of the present disclosure will be described with reference to the drawings.

### First Example Embodiment

An outline of a terminal device according to the present disclosure will be described. The terminal device is used to carry out identity verification of a user. Specifically, the user performs, using the terminal device, a predetermined procedure with respect to a service provider.

The predetermined procedure may relate to, for example, a transaction with a financial institution, an insurance application, a product purchase, or the like. The predetermined procedure is not limited to those examples. At this time, the terminal device performs identity verification of the user.

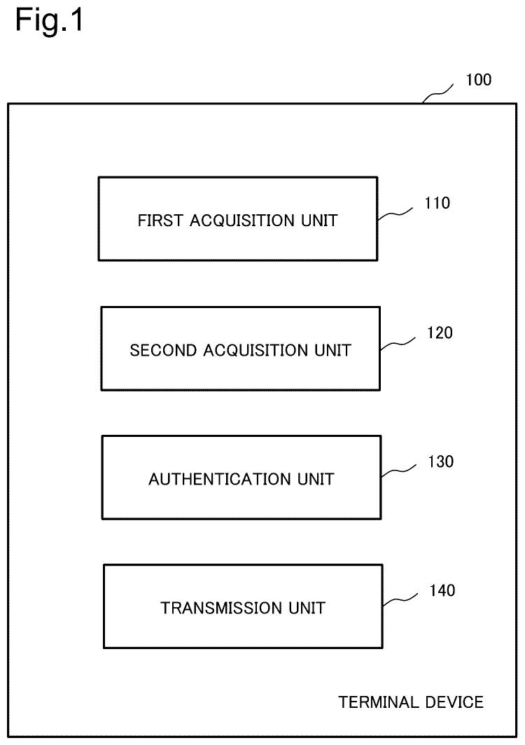

FIG. 1 is a block diagram illustrating an exemplary functional configuration of a terminal device 100. The terminal device 100 is a terminal used by the user. The terminal device 100 is, for example, a portable terminal such as a smartphone, a tablet terminal, or the like.

The terminal device 100 is not limited to this example, and may be a personal computer. The terminal device 100 has a camera function. The terminal device 100 further includes input/output equipment. Examples of the input/output equipment include a keyboard, a microphone, a display, a speaker, an integrated circuit (IC) card reader, and the like.

The terminal device 100 includes a first acquisition unit 110, a second acquisition unit 120, an authentication unit 130, and a transmission unit 140.

The first acquisition unit 110 acquires biological information of the user at a time of authenticating the user. The biological information is information relevant to a living body. A face is an example of the living body, but the living body is not limited to this example. The living body may indicate a body or voice of a person. The first acquisition unit 110 acquires biological information according to a result of measurement of the living body. An example of the measurement is imaging. For example, the face of the user is captured by the terminal device 100. The first acquisition unit 110 may acquire a facial image acquired by imaging the face of the user as the biological information. Such biological information according to the result of the measurement of the living body will be referred to as first biological information.

In this manner, the first acquisition unit 110 measures the body or voice of the user when authenticating the user, and acquires the first biological information, the first biological information being biological information according to a result of the measurement. The first acquisition unit 110 is an example of a first acquisition means.

The second acquisition unit 120 acquires information stored in an information storage medium. The information storage medium stores biological information and an electronic certificate. The biological information stored in the information storage medium will be referred to as second biological information. The second biological information is biological information relevant to the living body of the person. For example, the second biological information is a facial image of the person. The electronic certificate is information indicating authenticity of the person. For example, the electronic certificate is issued by an external certificate authority or the like. Examples of the information storage medium include an official certificate equipped with an IC chip.

The second biological information is, for example, a facial image of the person shown on the official certificate. That is, the information storage medium stores second biological information of a predetermined person and an electronic certificate indicating authenticity of the predetermined person.

In this case, in the terminal device 100, the second biological information and the electronic certificate stored in the information storage medium are read by an IC card reader function. The second acquisition unit 120 may acquire the read second biological information and electronic certificate. The information storage medium may be a storage device mounted on the terminal device 100.

In this manner, the second acquisition unit 120 acquires the second biological information and the electronic certificate indicating the authenticity of the person, the second biological information being biological information relevant to the body or voice of the person, the second biological information and the electronic certificate are stored in the information storage medium. The second acquisition unit 120 is an example of a second acquisition means.

The authentication unit 130 authenticates the user. Specifically, the authentication unit 130 carries out comparison based on the first biological information and the second biological information. For example, the authentication unit 130 compares a feature regarding the face extracted from the first biological information with a feature regarding the face extracted from the second biological information. If the comparison matches, the authentication unit 130 authenticates the user. The authentication method is not limited to this example. For example, the user may be authenticated by a method of calculating similarity of the entire image, such as pattern matching.

In this manner, the authentication unit 130 authenticates the user by the comparison based on the first biological information and the second biological information. The authentication unit 130 is an example of an authentication means.

The transmission unit 140 transmits various types of information. Specifically, when the user is authenticated by the authentication unit 130, the transmission unit 140 transmits the acquired electronic certificate and the authentication result. The authentication result includes information indicating whether the user is authenticated. The transmission unit 140 may transmit the electronic certificate and the authentication result to a provider server. The provider server may be a server operated by a service provider, which is a target of the procedure performed by the user. For example, it is assumed that the user performs a procedure for opening an account of a financial institution online. In this case, the provider server is a server operated by the financial institution or an institution entrusted by the financial institution.

As described above, when the user is authenticated, the transmission unit 140 transmits the acquired electronic certificate and the authentication result. The transmission unit 140 is an example of a transmission means.

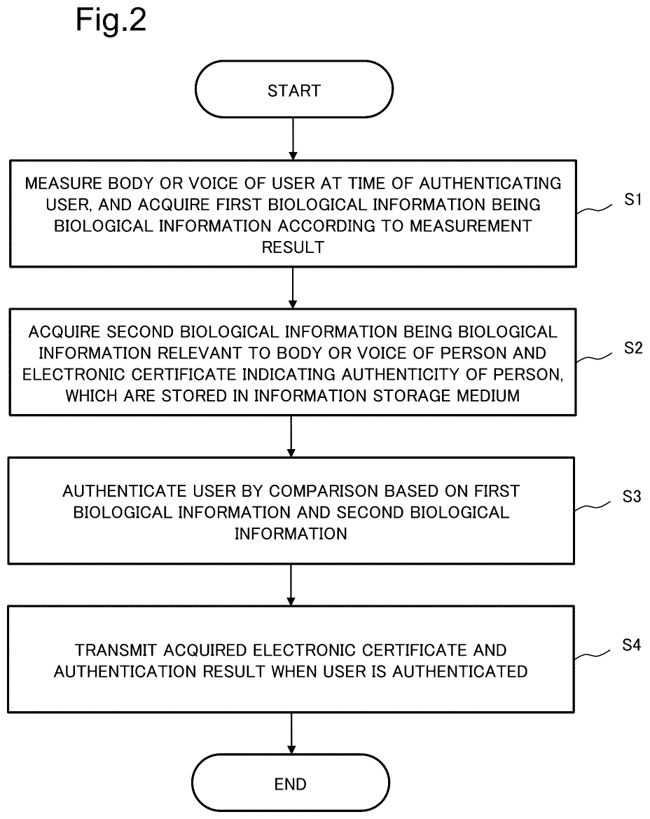

Next, exemplary operation of the terminal device 100 will be described with reference to FIG. 2. In the present disclosure, each step of a flowchart is represented using a number assigned to each step, such as “S1”.

FIG. 2 is a flowchart for explaining exemplary operation of the terminal device 100. The first acquisition unit 110 measures the body or voice of the user at the time of authenticating the user, and acquires the first biological information, which is biological information according to a result of the measurement (S1). The second acquisition unit 120 acquires the second biological information that is biological information relevant to the body or voice of the person and the electronic certificate indicating the authenticity of the person, which are stored in the information storage medium (S2). The authentication unit 130 authenticates the user by comparison based on the first biological information and the second biological information (S3). When the user is authenticated, the transmission unit 140 transmits the acquired electronic certificate and the authentication result (S4).

As described above, the terminal device 100 according to the first example embodiment measures the body or voice of the user at the time of authenticating the user, acquires the first biological information being the biological information according to the result of the measurement. Further the terminal device 100 acquires the second biological information and the electronic certificate indicating the authenticity of the person, the second biological information being the biological information relevant to the body or voice of the person, the second biological information and the electronic certificate being stored in the information storage medium. The terminal device 100 authenticates the user by the comparison based on the first biological information and the second biological information. Then, when the user is authenticated, the terminal device 100 transmits the acquired electronic certificate and the authentication result.

In a case of performing the identity verification using a captured image of an official certificate attached with a facial portrait, the identity verification may not be accurately carried out if the surface of the official certificate is damaged. On the other hand, the terminal device 100 according to the first example embodiment uses the biological information including the electronic certificate indicating the authenticity of the person stored in the information storage medium. Thus, the terminal device 100 is enabled to carry out the identity verification without considering the state of the surface of the official certificate.

The terminal device 100 is capable of performing authentication based on possession of the information storage medium storing the electronic certificate described above and performing authentication using the biological information stored in the information storage medium. Thus, the terminal device 100 is enabled to reduce the risk of impersonation due to forgery of an official certificate or the like. That is, the terminal device 100 according to the first example embodiment is capable of appropriately performing the identity verification.

### Second Example Embodiment

Next, an identity verification assistance system including a terminal device according to a second example embodiment will be described. In the second example embodiment, the terminal device 100 described in the first example embodiment will be described in more detail. Description of contents overlapping with the contents described in the first example embodiment will be partially omitted.

In the second example embodiment, a situation will be described as an example in which a user performs a procedure for a financial institution online. More specifically, in the second example embodiment, it is assumed that the user performs a procedure for opening an account of a financial institution using the terminal device. The exemplary procedure to be described in the present example embodiment is merely an example. The identity verification assistance system according to the present disclosure is applicable to various procedures.

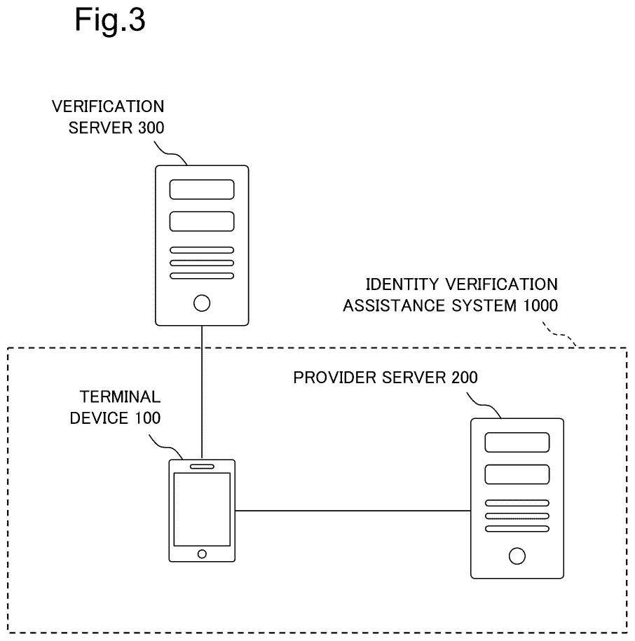

FIG. 3 is a diagram schematically illustrating an exemplary configuration including an identity verification assistance system 1000.

The identity verification assistance system 1000 includes a terminal device 100 and a provider server 200.

The terminal device 100 is communicably connected to the provider server 200 and a verification server 300 via a network. The provider server 200 is a server managed by a service provider. For example, the provider server 200 is managed by a financial institution or an institution entrusted by the financial institution. The provider server 200 accepts a procedure performed by the user. That is, the provider server receives an application for account opening.

The verification server 300 is a server that verifies validity of an electronic certificate. For example, the verification server 300 is a server managed by an institution, such as an external certificate authority, that manages electronic certificates.

For example, the user activates a dedicated application stored in the terminal device 100 to perform the procedure for opening an account. The processing of the terminal device 100 may be executed by the application. The user may activate a browser on the terminal device 100, access a website of the financial institution, and perform the procedure for opening an account.

### [Details of Identity Verification Assistance System 1000]

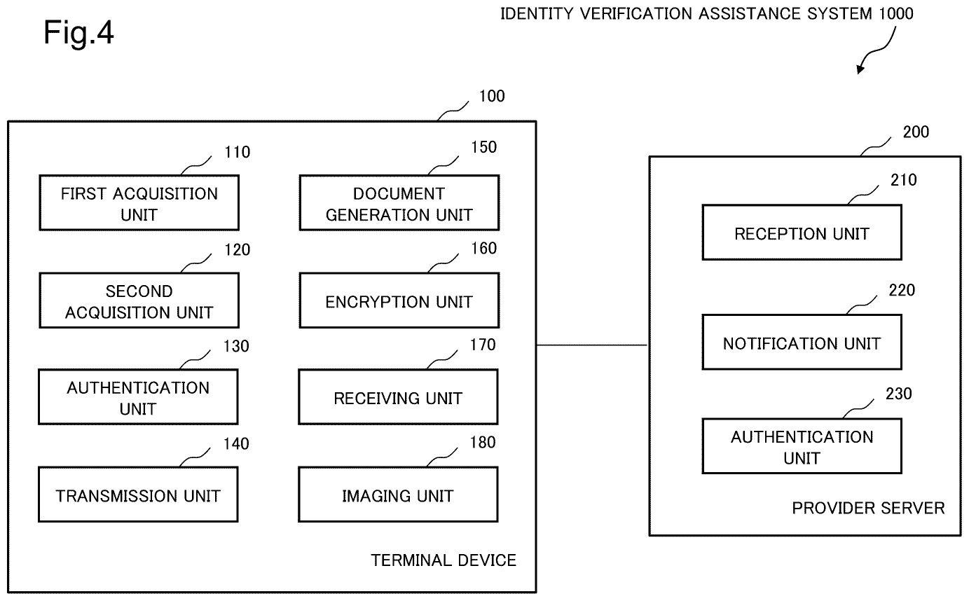

FIG. 4 is a block diagram illustrating an exemplary functional configuration of the identity verification assistance system 1000. The terminal device 100 includes a first acquisition unit 110, a second acquisition unit 120, an authentication unit 130, and a transmission unit 140. The terminal device 100 further includes a document generation unit 150, an encryption unit 160, a receiving unit 170, and an imaging unit 180.

The first acquisition unit 110 acquires first biological information of the user. Specifically, the face of the user is imaged by the imaging unit 180 of the terminal device 100. The first acquisition unit 110 acquires, from the imaging unit 180, a captured image acquired by imaging the face of the user.

The second acquisition unit 120 acquires information stored in an information storage medium. The information storage medium may be an official certificate. An individual number card is an example of the information storage medium. The individual number card is equipped with an IC chip. The IC chip stores a facial image of the owner of the individual number card and an electronic certificate. The IC chip further includes a public key. The electronic certificate includes an electronic certificate for signatures and an electronic certificate for user certification.

The electronic certificate for signatures is used at a time of creating or transmitting document information on the Internet or the like. The electronic certificate for signatures is information indicating that the document information is authentic and created by the owner of the individual number card. The electronic certificate for signatures includes a private key for signatures and four pieces of basic information of the owner. The private key is relevant to the public key included in the IC chip. That is, information encrypted with the private key is decrypted with the public key. The four pieces of basic information indicates a name, an address, a date of birth, and a gender. The electronic certificate for user certification is information indicating the user him/herself. The electronic certificate for user certification includes a private key for user certification.

The second acquisition unit 120 acquires at least the electronic certificate for signatures and the facial image of the owner, which are stored in the IC chip of the individual number card. The facial image of the owner is an example of second biological information. At this time, the terminal device 100 performs contactless communication, whereby information is read from the individual number card.

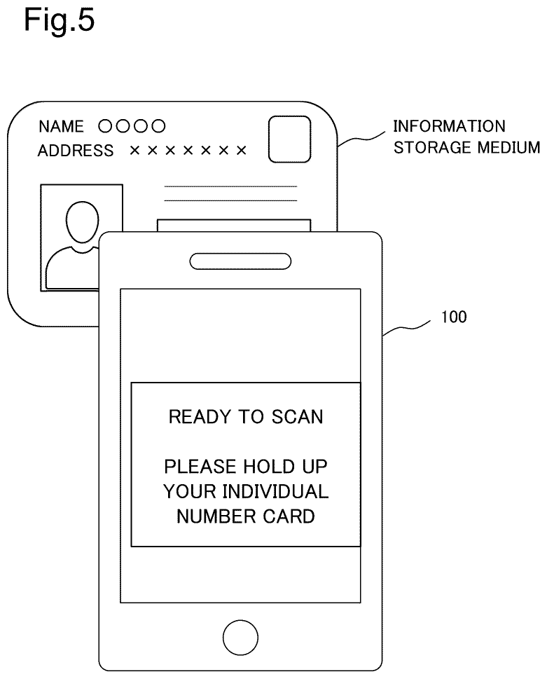

FIG. 5 is a diagram illustrating an exemplary situation in which information is read from the information storage medium. The terminal device 100 reads information stored in the information storage medium by contactless communication. For example, the information is read by near field communication (NFC) technology. The example of FIG. 5 illustrates an exemplary case where the terminal device 100 reads information from the individual number card. At this time, the second acquisition unit 120 may output guidance information for guiding an operation of reading the information from the information storage medium. In the example of FIG. 5, the text “Please hold up your individual number card” is shown on the display of the terminal device 100 as the guidance information. For example, the user holds the individual number card over the terminal device 100 in accordance with the guidance information shown on the display. As a result, the terminal device 100 reads the facial image and the electronic certificate for signatures from the individual number card. In this manner, the second acquisition unit 120 may acquire the facial image and the electronic certificate for signatures by reading the facial image and the electronic certificate for signatures from the information storage medium.

The second acquisition unit 120 may prompt for a passcode input when the operation of reading the information is performed. For example, after the user holds the individual number card over the terminal device 100, the second acquisition unit 120 receives the passcode input from the user. In this case, registration number information indicating the correct passcode is stored in the IC chip or in a storage device (not illustrated) included in the terminal device 100. When the input passcode matches the registration number information, the second acquisition unit 120 may read the information from the individual number card. When the input passcode does not match the registration number information, the second acquisition unit 120 may prompt for the passcode input again, or may output information indicating failure in reading the information in the terminal device 100. As described above, by using the passcode at the time of acquiring the information from the information storage medium, the terminal device 100 is further enabled to perform knowledge authentication.

The method of acquiring the information by the second acquisition unit 120 is not limited to this example. For example, the second acquisition unit 120 may acquire various types of information by contact-type communication performed in the terminal device 100. In this case, a terminal of a card reader communicably connected to the terminal device 100 and the IC chip of the individual number card come into contact with each other, whereby information is read.

While the exemplary case where the information storage medium is the individual number card has been mainly described above, the information storage medium is not necessarily the individual number card. It is sufficient if the information storage medium is an official certificate equipped with an IC chip storing a facial image and an electronic certificate as described above. The second acquisition unit 120 may acquire the public key from the information storage medium in a similar manner. In the case where the information storage medium is an individual number card, the second acquisition unit 120 may acquire the electronic certificate for user certification in a similar manner.

The authentication unit 130 authenticates the user based on the first biological information acquired by the first acquisition unit 110 and the second biological information acquired by the second acquisition unit 120. Specifically, the authentication unit 130 compares a captured image acquired by imaging the face of the user with the facial image stored in the information storage medium. At this time, for example, the authentication unit 130 extracts a feature of the face from the captured image (first biological information). The authentication unit 130 further extracts a feature of the face from the facial image (second biological information). Then, the authentication unit 130 compares the extracted features. A match of the comparison indicates that the user has been authenticated. A mismatch of the comparison indicates that the user has not been authenticated. The authentication unit 130 generates an authentication result. A general facial matching technique may be used as a method of authenticating the user.

The transmission unit 140 transmits various types of information. When the user is authenticated by the authentication unit 130, the transmission unit 140 transmits, to the provider server 200, the electronic certificate acquired by the second acquisition unit 120 and the authentication result generated by the authentication unit 130. At this time, the transmission unit 140 further transmits, to the provider server 200, the public key and encrypted document information to be described later.

The transmission unit 140 further transmits the electronic certificate to the verification server 300. As a result, the verification server 300 verifies the validity of the electronic certificate. When the user is authenticated and the validity of the electronic certificate is verified, the transmission unit 140 may transmit the authentication result and the electronic certificate to the provider server 200.

When the user is not authenticated by the authentication unit 130, the transmission unit 140 may transmit the first biological information and the second biological information to the provider server 200. In this case, the provider server 200 performs authentication processing. The authentication processing by the provider server will be described later.

The document generation unit 150 generates document information associated with a procedure. The document generation unit 150 is an example of a document generation means. The document information indicates a document associated with the procedure. In the case where the procedure performed by the user is account opening, the document information is an account opening application form. The document generation unit 150 receives an input operation from the user, and generates document information to which information according to the input operation is input.

The encryption unit 160 encrypts the document information. The encryption unit 160 is an example of an encryption means. Specifically, the encryption unit 160 encrypts the document information using the private key included in the electronic certificate acquired by the second acquisition unit 120. In the case where the information storage medium is an individual number card, the encryption unit 160 encrypts the document information using the private key for signatures.

The receiving unit 170 receives various types of information. The receiving unit 170 is an example of a receiving means. The receiving unit 170 receives implementation status information from the provider server 200. The receiving unit 170 outputs the received implementation status information to the terminal device 100. Details of the implementation status information will be described later.

The receiving unit 170 further receives a verification result regarding the validity of the electronic certificate from the verification server 300.

The provider server 200 includes a reception unit 210, a notification unit 220, and an authentication unit 230. The reception unit 210 receives information transmitted from the terminal device 100. For example, the reception unit 210 receives, from the terminal device 100, the authentication result, the encrypted document information, the electronic certificate, and the public key. When the reception unit 210 receives the encrypted document information and the public key, the reception unit 210 decrypts the document information using the public key. As a result, the provider server 200 accepts the procedure. Descriptions of an examination of the procedure based on the contents of the document information will be omitted.

The reception unit 210 may further receive the first biological information and the second biological information from the terminal device 100. In this case, the authentication unit 230 carries out the authentication processing.

The authentication unit 230 extracts a feature regarding the face from each of the received first biological information and second biological information. Then, the authentication unit 230 carries out the authentication processing by comparing the extracted features. The authentication unit 230 generates an external authentication result indicating a result of the authentication processing.

The notification unit 220 makes various types of notification to the terminal device 100. Specifically, the notification unit 220 transmits the implementation status information to the terminal device 100. The implementation status information indicates an implementation status of the procedure based on the electronic certificate and the authentication result. For example, the implementation status information may indicate completion of the procedure, or may indicate incompletion of the procedure due to some deficiencies.

The notification unit 220 may further transmit the external authentication result to the terminal device 100.

### [Exemplary Operation of Identity Verification Assistance System 1000]

Exemplary operation of the identity verification assistance system 1000 will be described. In the present exemplary operation, operation of each of the terminal device 100 and the provider server 200 will be described.

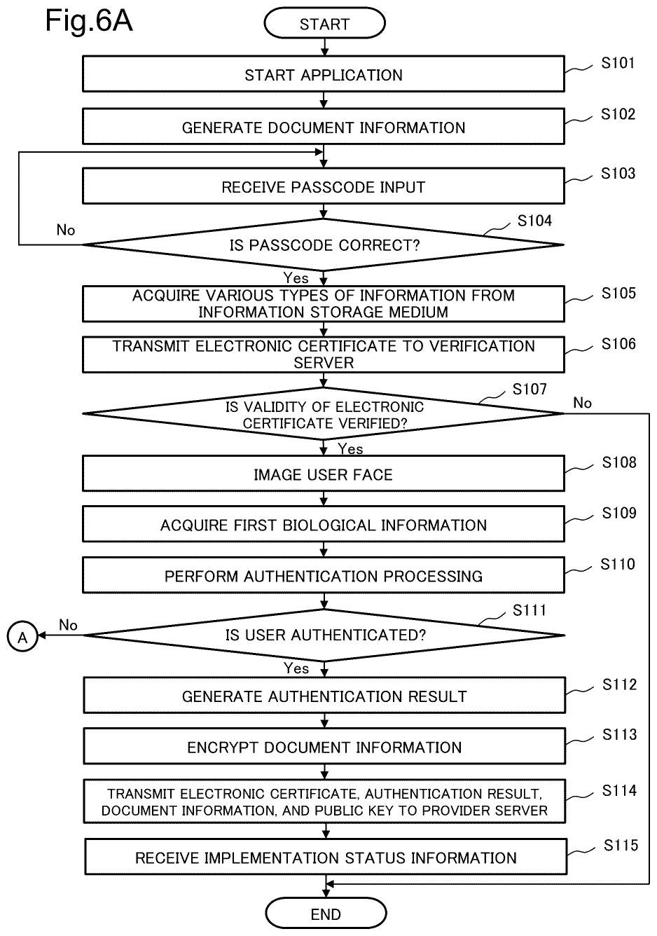

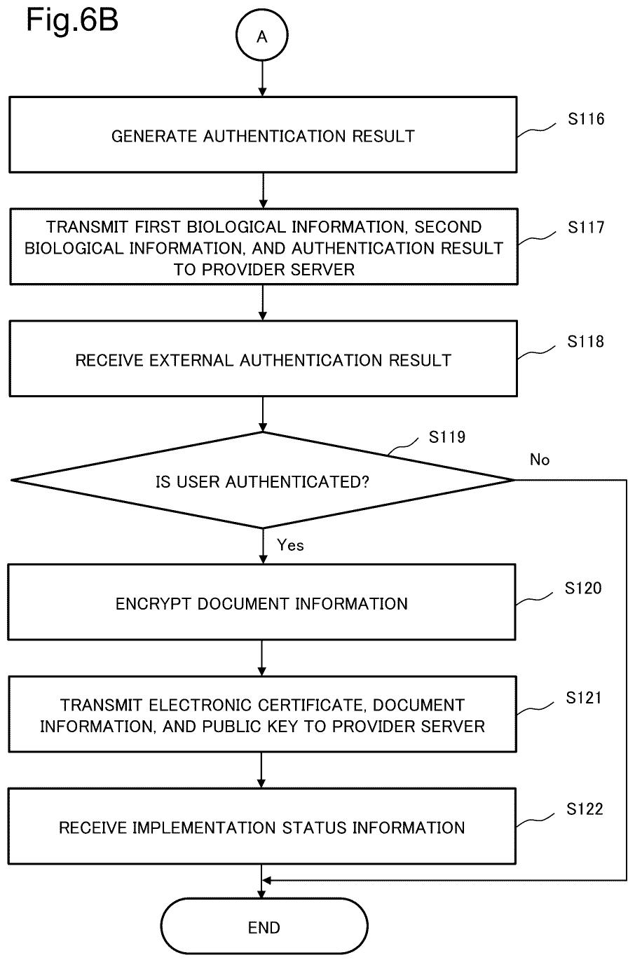

FIG. 6A is a flowchart for explaining first exemplary operation of the terminal device 100. First, an application is activated in the terminal device 100 by an operation made by the user (S101). Examples of the application include an application for opening an account. The document generation unit 150 generates document information associated with a procedure (S102). The document information is information to which information according to the input operation made by the user is input.

Next, the terminal device 100 reads information from the information storage medium. Specifically, an information reading function is activated by a user operation. At this time, the second acquisition unit 120 outputs guidance information for guiding an operation of reading information. The user holds the information storage medium over the terminal device 100 in accordance with the guidance information. The second acquisition unit 120 receives an input of a passcode (S103). If the input passcode is correct (“Yes” in S104), the second acquisition unit 120 acquires various types of information from the information storage medium (S105). For example, the second acquisition unit 120 acquires an electronic certificate, a facial image, and a public key. The facial image corresponds to the second biological information. If the input passcode is incorrect (“No” in S104), the second acquisition unit 120 may receive the passcode input again. At this time, the process may be terminated if the passcode is input a predetermined number of times but remains incorrect.

After the processing of S105, the transmission unit 140 transmits the electronic certificate to the verification server 300 (S106). As a result, the verification server 300 verifies the validity of the electronic certificate. Then, the receiving unit 170 receives a verification result regarding the validity of the electronic certificate from the verification server 300. If the validity of the electronic certificate is not verified (“No” in S107), the terminal device 100 may terminate the process. If the validity of the electronic certificate is verified (“Yes” in S107), the imaging unit 180 images the face of the user (S108).

The first acquisition unit 110 acquires, as the first biological information, the captured image imaged by the imaging unit 180 (S109). The authentication unit 130 carries out authentication processing (S110). Specifically, the authentication unit 130 extracts a feature of the face from each of the second biological information acquired in the processing of S105 and the first biological information acquired in the processing of S109. Then, the authentication unit 130 carries out the authentication processing by comparing the extracted features.

If the user is authenticated (“Yes” in S111), the authentication unit 130 generates an authentication result indicating that the user has been authenticated (S112). The encryption unit 160 encrypts the document information using the private key included in the electronic certificate (S113).

The transmission unit 140 transmits, to the provider server 200, the electronic certificate, the authentication result, the encrypted document information, and the public key (S114). At this time, the transmission unit 140 may transmit the encrypted document information and the document information before being encrypted.

The receiving unit 170 receives the implementation status information from the provider server 200 (S115).

If the user is not authenticated in the processing of S111 (“No” in S111), the terminal device 100 performs a process illustrated in FIG. 6B.

FIG. 6B is a flowchart for explaining second exemplary operation of the terminal device 100. At this time, the authentication unit 130 generates an authentication result indicating that the user has not been authenticated (S116). The transmission unit 140 transmits, to the provider server 200, the first biological information, the second biological information, and the authentication result (S117).

The receiving unit 170 receives the external authentication result from the provider server 200 (S118). If the external authentication result indicates that the user has been authenticated (“Yes” in S119), the encryption unit 160 encrypts the document information using the private key included in the electronic certificate (S120). The transmission unit 140 transmits, to the provider server 200, the electronic certificate, the authentication result, the encrypted document information, and the public key (S121). Then, the receiving unit 170 receives the implementation status information from the provider server 200 (S122).

If the external authentication result indicates that the user has not been authenticated in the processing of S119 (“No” in S119), the terminal device 100 may terminate the process.

In each case where the user has not been authenticated, the document generation unit 150 may temporarily store the generated document information.

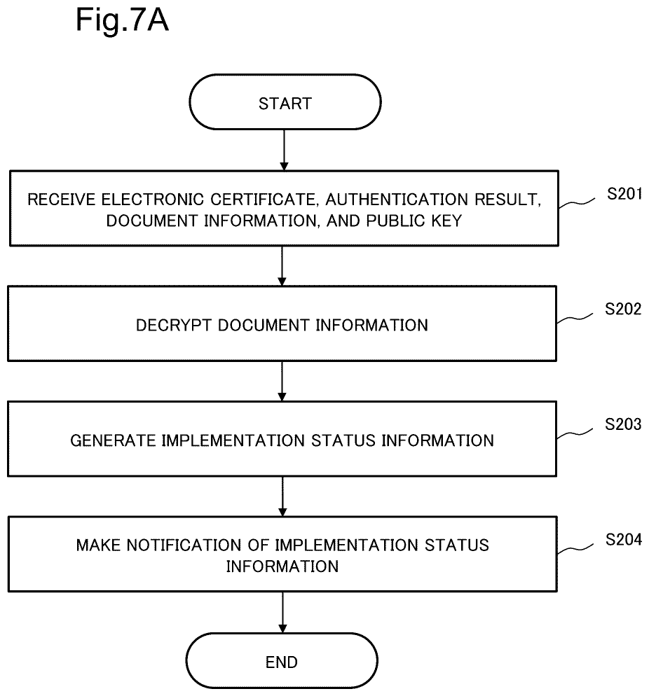

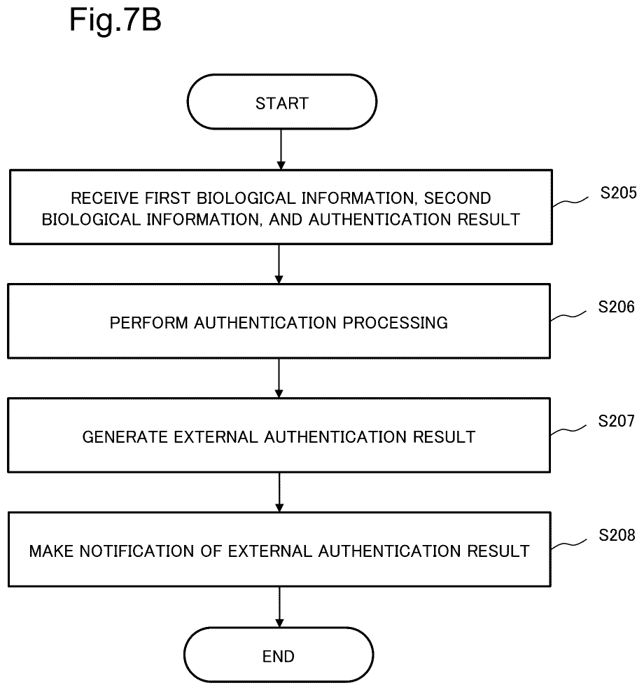

Next, exemplary operation of the provider server 200 will be described. FIG. 7A is a flowchart for explaining first exemplary operation of the provider server 200. Specifically, FIG. 7A illustrates an operation to be performed by the provider server 200 after the terminal device 100 performs the processing of S114.

The reception unit 210 of the provider server 200 receives, from the terminal device 100, the electronic certificate, the authentication result, the encrypted document information, and the public key (S201). The reception unit 210 decrypts the encrypted document information using the public key (S202). The notification unit 220 generates implementation status information (S203). For example, when the provider server 200 duly accepts the procedure, the notification unit 220 generates implementation status information indicating completion of the procedure. For example, when there is a deficiency in the procedure, the notification unit 220 generates implementation status information indicating incompletion of the procedure. Then, the notification unit 220 notifies the terminal device 100 of the implementation status information (S204). Thereafter, the terminal device 100 performs the processing of S115.

After the processing of S121 is performed in the terminal device 100, the provider server 200 performs the process similar to that in FIG. 7A.

Next, exemplary operation of the provider server 200 will be further described. FIG. 7B is a flowchart for explaining second exemplary operation of the provider server 200. Specifically, FIG. 7B illustrates an operation to be performed by the provider server 200 after the terminal device 100 performs the processing of S117.

The reception unit 210 of the provider server 200 receives, from the terminal device 100, the first biological information, the second biological information, and the authentication result (S205). The authentication unit 230 carries out authentication processing based on the first biological information and the second biological information (S206). For example, the biometric authentication engine of the provider server 200 may have better performance than that of the biometric authentication engine of the terminal device 100. In view of the above, when the authentication fails in the terminal device 100, the provider server 200 may perform the authentication processing.

Then, the authentication unit 230 generates an external authentication result indicating the authentication result (S207). The notification unit 220 notifies the terminal device 100 of the external authentication result (S208). Thereafter, the terminal device 100 performs the processing of S118.

The present exemplary operation is merely an example, and the operation of the identity verification assistance system 1000 is not limited to the operation described above. The order of the processing may be changed as appropriate. For example, the processing of S108 and S109 for acquiring the first biological information may be performed at a timing earlier than that in the example described above. The processing of S103 to S111 may be performed before the document information is generated.

In the exemplary operation described above, the exemplary operation of the identity verification performed when the user carries out a predetermined procedure has been described. Thus, the exemplary operation includes the generation and transmission/reception of the document information associated with the procedure. If only the identity verification is first carried out at the time of the procedure, the processing associated with the generation, transmission/reception, and the like of the document information may not be performed.

As described above, the terminal device 100 according to the second example embodiment measures the body or voice of the user at the time of authenticating the user, acquires the first biological information that is the biological information according to the result of the measurement, and further acquires the second biological information that is the biological information relevant to the body or voice of the person and the electronic certificate indicating the authenticity of the person, which are stored in the information storage medium. The terminal device 100 authenticates the user by the comparison based on the first biological information and the second biological information. Then, when the user is authenticated, the terminal device 100 transmits the acquired electronic certificate and the authentication result.

In a case of performing the identity verification using a captured image of an official certificate attached with a facial portrait, the identity verification may not be accurately carried out if the surface of the official certificate is damaged. On the other hand, the terminal device 100 according to the second example embodiment uses the biological information including the electronic certificate indicating the authenticity of the person stored in the information storage medium. Thus, the terminal device 100 is enabled to carry out the identity verification without considering the state of the surface of the official certificate.

The terminal device 100 is capable of performing authentication based on possession of the information storage medium storing the electronic certificate described above and performing authentication using the biological information stored in the information storage medium. Thus, the terminal device 100 is enabled to reduce the risk of impersonation due to forgery of an official certificate or the like. That is, the terminal device 100 according to the second example embodiment is capable of appropriately performing the identity verification.

When the user is not authenticated, the terminal device 100 may transmit the first biological information and the second biological information to a server capable of performing authentication processing. Then, the terminal device 100 may transmit the electronic certificate when it receives information indicating a result of the authentication processing based on the first biological information and the second biological information and the received result indicates that the user has been authenticated.

The authentication processing may fail in the terminal device 100. Meanwhile, an external server may include an authentication engine having better performance than that of the terminal device 100. In such a case, the terminal device 100 may cause the external server to perform the authentication processing, whereby the identity verification may be carried out more appropriately.

The terminal device 100 may transmit the electronic certificate and the authentication result to a server that accepts the procedure performed by the user, and may receive implementation status information indicating an implementation status of the procedure based on the transmitted electronic certificate and authentication result. As a result, the user may be notified of the implementation status of the procedure.

The terminal device 100 may generate document information associated with the procedure, and may further transmit the document information when the user is authenticated. At this time, the terminal device 100 may acquire the private key and the public key relevant to the private key stored in the information storage medium, and may encrypt the document information based on the private key. Then, when the user is authenticated, the terminal device 100 may transmit the public key and the encrypted document information. With this arrangement, the terminal device 100 may also be applied to a personal authentication service based on a public key cryptosystem.

### [First Modification]

When the user authentication fails in the terminal device 100, the terminal device 100 may perform the authentication processing a predetermined number of times.

For example, it is assumed that the user is not authenticated in the processing of S111. At this time, the terminal device 100 may return to the processing of S108. That is, the imaging unit 180 images the face of the user again. The first acquisition unit 110 acquires a captured image imaged again. In other words, the first acquisition unit 110 re-acquires, as the first biological information, biological information different from the previously acquired first biological information. Then, the authentication unit 130 may authenticate the user by comparison between the re-acquired first biological information and the second biological information.

If the number of times the user fails to be authenticated (i.e., number of authentication failures) exceeds a predetermined number of times, the terminal device 100 may proceed to the processing of “No” in S111.

The authentication unit 130 may generate an authentication result including the number of authentication failures. With this arrangement, the service provider may be notified of the number of authentication failures. The service provider is enabled to consider the information regarding the number of times in the procedure.

As described above, when the user is not authenticated, the terminal device 100 according to the first modification may acquire the first biological information of the user again, and may authenticate the user by the comparison between the re-acquired first biological information and the second biological information.

### [Second Modification]

The exemplary case of using a facial image as biological information has been described in the example embodiments above. An example of the biological information is not limited to this example. The biological information may be voice information, an iris image, a retinal image, fingerprint information, or the like. That is, voiceprint authentication, iris authentication, retinal authentication, fingerprint authentication, or the like may be carried out as the authentication processing.

For example, when the biological information is voice information, the voice of the user is measured by a microphone of the terminal device 100. The first acquisition unit 110 acquires voice information relevant to the measured voice as the first biological information. The information storage medium stores voice information indicating the voice of the user in advance. The second acquisition unit 120 acquires the stored voice information as the second biological information. Then, the authentication unit 130 carries out voiceprint authentication based on the first biological information and the second biological information.

As described above, various types of biometric authentication may be applied in the present disclosure.

[Third modification]

The exemplary case where the information storage medium is an official certificate, such as an individual number card, has been described in the example embodiments above. The information storage medium is not limited to this example.

For example, the information storage medium may be a storage medium included in the terminal device 100. That is, the terminal device 100 may have the electronic certificate and the biological information of the user. In other words, the terminal device 100 may be a device having a function of an official certificate, such as an individual number card.

### [Fourth Modification]

The exemplary case where the terminal device 100 causes the verification server 300 to verify the validity of the electronic certificate has been described in the example embodiments above. It is not limited to this example, and the provider server 200 may cause the verification server 300 to verify the validity.

For example, after the processing of S201, the reception unit 210 of the provider server 200 transmits the electronic certificate to the verification server 300. Then, the reception unit 210 receives a verification result regarding the validity of the electronic certificate from the verification server 300. If the validity of the electronic certificate is verified, the provider server 200 performs the processing of S202 and subsequent steps. If the validity of the electronic certificate is not verified, the notification unit 220 notifies the terminal device 100 of implementation status information indicating incompletion of the procedure.

In this case, the terminal device 100 does not necessarily perform the processing of S106 and S107.

### [Fifth Modification]

The method of acquiring the second biological information is not limited to the example described above.

Specifically, the information storage medium may not store the biological information. For example, an external server stores a database of facial images of persons in advance. The external server operates a website that may access personal information including facial images. The terminal device 100 logs in to the website using the electronic certificate acquired from the information storage medium. Then, the second acquisition unit 120 may acquire a facial image through the website.

### Third Example Embodiment

Next, an identity verification assistance system according to a third example embodiment will be described. In the third example embodiment, an exemplary function of the identity verification assistance system will be further described. Description of contents overlapping with the contents described in the first and second example embodiments will be partially omitted.

While an exemplary case where biological information is a facial image will be described also in the present example embodiment, the biological information is not limited to this example as described above.

### [Details of Identity Verification Assistance System 1001]

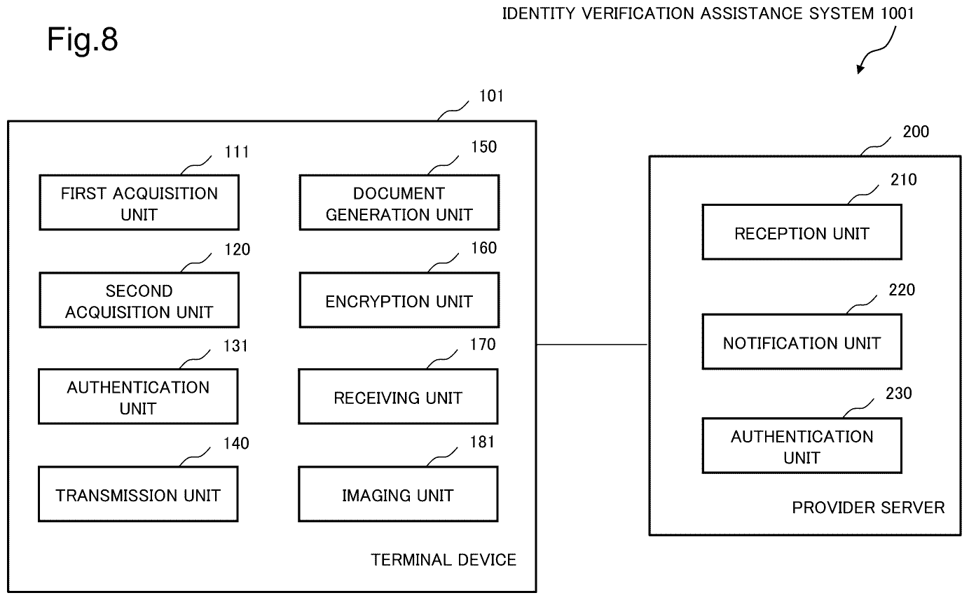

FIG. 8 is a block diagram illustrating an exemplary functional configuration of an identity verification assistance system 1001 according to the third example embodiment. As illustrated in FIG. 8, the identity verification assistance system 1001 includes a terminal device 101 and a provider server 200.

The terminal device 101 includes a first acquisition unit 111, a second acquisition unit 120, an authentication unit 130, and a transmission unit 140. The terminal device 101 further includes a document generation unit 150, an encryption unit 160, a receiving unit 170, and an imaging unit 181.

The first acquisition unit 111 may acquire biological information of a user as appropriate. Specifically, the first acquisition unit 111 acquires third biological information at a timing different from the timing at which first biological information to be used for identity verification is acquired.

Specifically, the first acquisition unit 111 may acquire the third biological information at a predetermined timing before the first biological information is acquired. For example, it is assumed that the first acquisition unit 111 acquires a facial image as the first biological information. Prior to that, the first acquisition unit 111 acquires a facial image of the user operating the terminal device 101. In this case, the imaging unit 181 images the face of the user before capturing the facial image that serves as the first biological information. For example, the imaging unit 181 images the face of the user when an application for performing a procedure of the terminal device 101 is activated. Then, the first acquisition unit 111 acquires, as the third biological information, the facial image captured by the imaging unit 181.

Likewise, the first acquisition unit 111 may acquire the third biological information at a predetermined timing after the first biological information is acquired. At this time, the terminal device 101 may or may not display the image being captured by the imaging unit 181. When the user is performing an operation related to the procedure, the image being captured may be displayed on a part of the display of the terminal device 101.

As described above, the first acquisition unit 111 may acquire the third biological information of the user operating the terminal device 101 at a timing different from the timing at which the first biological information is acquired.

An authentication unit 131 authenticates the user by comparison based on the first biological information and the third biological information. That is, the authentication unit 131 may carry out authentication processing different from the authentication based on the first biological information and the second biological information. The authentication based on the first biological information and the second biological information is to verify whether the user is a person indicated by an information storage medium. On the other hand, the authentication based on the first biological information and the third biological information is to verify whether the user making an operation is the same.

Here, the authentication based on the first biological information and the second biological information will be referred to as first authentication. The authentication based on the first biological information and the third biological information will be referred to as second authentication.

The first acquisition unit 111 may acquire the third biological information multiple times. The authentication unit 131 may carry out the second authentication in response to acquisition of the third biological information.

### [Exemplary Operation of Identity Verification Assistance System 1001]

Exemplary operation of the identity verification assistance system 1001 will be described. In the present exemplary operation, operation of each of the terminal device 101 and the provider server 200 will be described. Description of processing similar to that of the second example embodiment will be partially omitted.

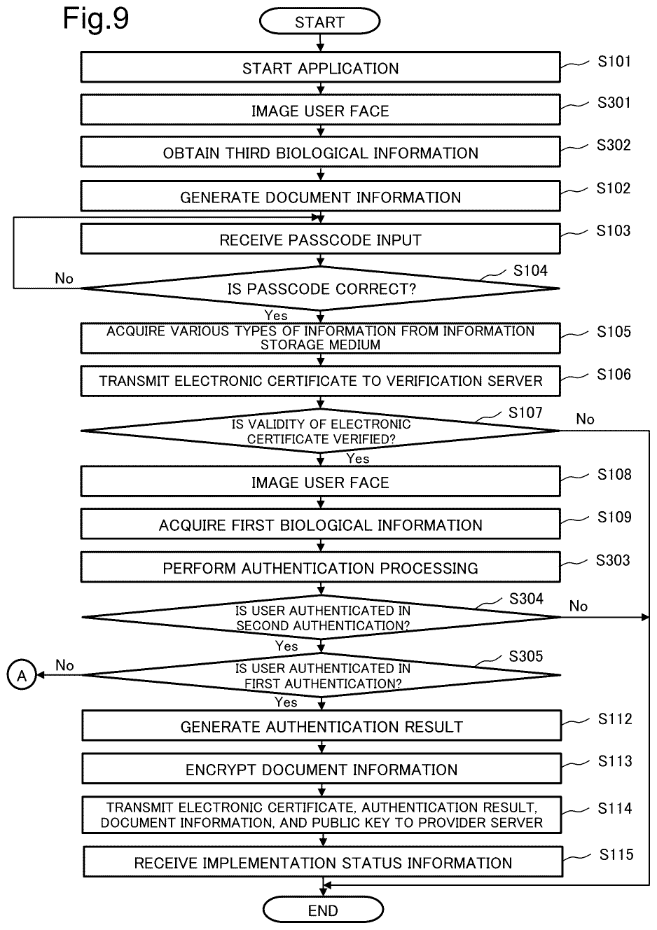

FIG. 9 is a flowchart for explaining exemplary operation of the terminal device 101. First, an application is activated in the terminal device 101 by an operation made by the user (S101). Then, the imaging unit 181 images the face of the user (S301). The first acquisition unit 110 acquires, as the third biological information, the captured image imaged by the imaging unit 180 (S302). The processing of S102 to S109 is similar to the example of FIG. 6A.

The authentication unit 130 carries out authentication processing (S303). Specifically, the authentication unit 130 carries out the first authentication based on the first biological information and the second biological information, and the second authentication based on the first biological information and the second biological information.

If the user is not authenticated in the second authentication (“No” in S304), the terminal device 101 may terminate the process. If the user is authenticated in the second authentication (“Yes” in S304) and the user is authenticated in the first authentication (“Yes” in S305), the terminal device 101 may perform the processing of S112 and subsequent steps. If the user is not authenticated in the first authentication (“No” in S305), the terminal device 101 may perform the operation in FIG. 6B.

As described above, the terminal device 101 according to the third example embodiment may measure the body or voice of the user operating the terminal device itself at a timing different from the timing at which the first biological information is acquired, and may acquire the third biological information, which is biological information according to a result of the measurement. Then, the terminal device 101 may authenticate the user by the comparison based on the first biological information and the third biological information.

A third party other than the legitimate user may swap during the operation related to the procedure, and may impersonate the legitimate user. On the other hand, the authentication based on the first biological information and the third biological information is to verify whether the user making the operation is the same. Thus, the terminal device 101 according to the third example embodiment is capable of suppressing such impersonation of the user.

### <Exemplary Hardware Configuration of Identity Verification Assistance System>

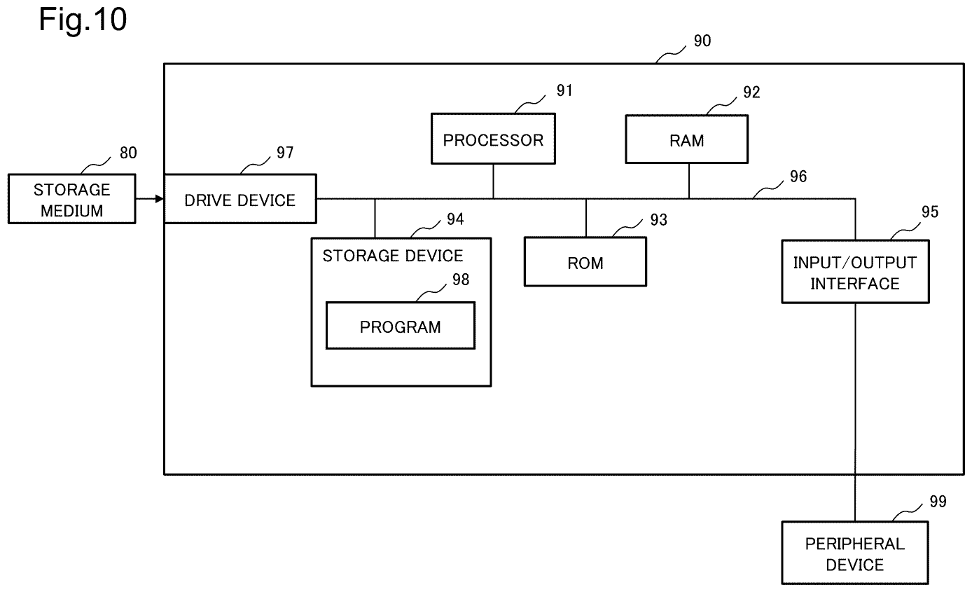

Hardware constituting the identity verification assistance system according to the first, second, and third example embodiments described above will be described. FIG. 10 is a block diagram illustrating an exemplary hardware configuration of a computer device that implements the identity verification assistance system according to each example embodiment. In a computer device 90, the identity verification assistance system and the identity verification assistance method described in each example embodiment and each modification are implemented. More specifically, the identity verification assistance system and the identity verification assistance method described in each example embodiment and each modification are implemented in the computer device 90. For example, each of the terminal device, the provider server, and the like described in each example embodiment and each modification may have the hardware configuration illustrated in FIG. 10.

As illustrated in FIG. 10, the computer device 90 includes a processor 91, a random access memory (RAM) 92, a read only memory (ROM) 93, a storage device 94, an input/output interface 95, a bus 96, and a drive device 97. The terminal device and the provider server may be implemented by multiple electric circuits.

The storage device 94 stores a program (computer program) 98. The processor 91 executes the program 98 of the identity verification assistance system using the RAM 92. Specifically, for example, the program 98 includes a program that causes a computer to execute the process illustrated in FIGS. 6A, 6B, 7A, 7B, and 9. Functions of individual components of the identity verification assistance system are implemented in response to the processor 91 executing the program 98. The program 98 may be stored in the ROM 93. The program 98 may be recorded in a storage medium 80 and read using the drive device 97, or may be transmitted from an external device (not illustrated) to the computer device 90 via a network (not illustrated).

The input/output interface 95 exchanges data with a peripheral device (keyboard, mouse, display device, etc.) 99. The input/output interface 95 functions as a means for acquiring or outputting data. The bus 96 connects individual components.

There are various modifications of the method of implementing the identity verification assistance system. For example, the identity verification assistance system may be implemented as a dedicated device. The identity verification assistance system, the terminal device, and the provider server may be implemented based on a combination of multiple devices.

Processing methods of causing a storage medium to record a program for implementing each component in the functions of each example embodiment, reading the program recorded in the storage medium as a code, and executing the program in a program are also included in the scope of each example embodiment. That is, a computer-readable storage medium is also included in the scope of each example embodiment. The storage medium recording the program described above and the program itself are also included in each example embodiment.

The storage medium is, for example, a floppy (registered trademark) disk, a hard disk, an optical disk, a magneto-optical disk, a compact disc (CD)-ROM, a magnetic tape, a nonvolatile memory card, or a ROM, but is not limited to this example. The program recorded in the storage medium is not limited to a program that executes processing by itself, and programs that operate on an operating system (OS) to execute processing in cooperation with other software and functions of an extension board are also included in the scope of each example embodiment.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

The example embodiments and modifications described above may be appropriately combined.

Some or all of the example embodiments described above may be described as the following Supplementary Notes, but are not limited to the following.

### Supplementary Note

### [Supplementary Note 1]

A terminal device including:
a first acquisition means for measuring a body or voice of a user when authenticating the user and acquiring first biological information, the first biological information being biological information according to a result of the measurement;
a second acquisition means for acquiring second biological information and an electronic certificate indicating authenticity of a person, the second biological information being biological information relevant to a body or voice of the person, the second biological information and the electronic certificate being stored in an information storage medium;
an authentication means for authenticating the user by comparison based on the first biological information and the second biological information; and
a transmission means for transmitting the acquired electronic certificate and an authentication result when the user is authenticated.

### [Supplementary Note 2]

The terminal device according to Supplementary Note 1, further including:
a receiving means, in which
when the user is not authenticated, the transmission means transmits the first biological information and the second biological information to a server capable of performing authentication processing,
the receiving means receives information indicating a result of the authentication processing based on the first biological information and the second biological information, and
when the received result indicating the user has been authenticated, the transmission means transmits the electronic certificate.

### [Supplementary Note 3]

The terminal device according to Supplementary Note 1 or 2, in which
the first acquisition means measures the body or voice of the user operating the terminal device at a timing different from a timing at which the first biological information is acquired, and acquires third biological information, the third biological information being biological information according to a result of the measurement, and
the authentication means authenticates the user by comparison based on the first biological information and the third biological information.

### [Supplementary Note 4]

The terminal device according to any one of Supplementary Notes 1 to 3, further including:
a receiving means, in which
the transmission means transmits the electronic certificate and the authentication result to a server accepting a procedure performed by the user, and
the receiving means receives implementation status information indicating an implementation status of the procedure based on the electronic certificate and the authentication result that have been transmitted.

### [Supplementary Note 5]

The terminal device according to any one of Supplementary Notes 1 to 4, further including:
a document generation means for generating document information associated with the procedure, in which
the transmission means further transmits the document information when the user is authenticated.

### [Supplementary Note 6]

The terminal device according to Supplementary Note 5, further including:
an encryption means for encrypting the document information, in which
the second acquisition means acquires a private key and a public key relevant to the private key stored in the information storage medium,
the encryption means encrypts the document information based on the private key, and
when the user is authenticated, the transmission means transmits the public key and the encrypted document information.

### [Supplementary Note 7]

The terminal device according to Supplementary Note 5 or 6, in which
when the user is not authenticated, the document generation means temporarily stores the generated document information.

### [Supplementary Note 8]

An identity verification assistance method including:
in a terminal operated by a user,
measuring a body or voice of the user when authenticating the user and acquiring first biological information, the first biological information being biological information according to a result of the measurement;
acquiring second biological information and an electronic certificate indicating authenticity of a person, the second biological information being biological information relevant to a body or voice of the person, the second biological information and the electronic certificate being stored in an information storage medium;
authenticating the user by comparison based on the first biological information and the second biological information; and
transmitting the acquired electronic certificate and an authentication result when the user is authenticated.

### [Supplementary Note 9]

A computer-readable storage medium storing a program for executing a process including:
in a terminal operated by a user,
measuring a body or voice of the user when authenticating the user and acquiring first biological information, the first biological information being biological information according to a result of the measurement;
acquiring second biological information and an electronic certificate indicating authenticity of a person, the second biological information being biological information relevant to a body or voice of the person, and an electronic certificate indicating authenticity of the person, the second biological information and the electronic certificate being stored in an information storage medium;
authenticating the user by comparison based on the first biological information and the second biological information; and
transmitting the acquired electronic certificate and an authentication result when the user is authenticated.

### REFERENCE SIGNS LIST

100, 101 terminal device
110, 111 first acquisition unit
120 second acquisition unit
130, 131 authentication unit
140 transmission unit
150 document generation unit
160 encryption unit
170 receiving unit
180, 181 imaging unit
200 provider server
210 reception unit
220 notification unit
230 authentication unit
300 verification server
1000, 1001 identity verification assistance system

What is claimed is:

1. A terminal device comprising:
a memory; and
at least one processor coupled to the memory
the at least one processor performing operations to:
a measure a body or voice of a user when authenticating the user;
acquire first biological information, the first biological information being biological information according to a result of the measurement;
acquire second biological information and an electronic certificate indicating authenticity of a person, the second biological information being biological information relevant to a body or voice of the person, the second biological information and the electronic certificate being stored in an information storage medium;
authenticate the user by comparison based on the first biological information and the second biological information; and
transmit the acquired electronic certificate and an authentication result when the user is authenticated.

2. The terminal device according to claim 1, wherein the at least one processor further performs operation to:
when the user is not authenticated, transmit the first biological information and the second biological information to a server capable of performing authentication processing,
receive information indicating a result of the authentication processing based on the first biological information and the second biological information, and
when the received result indicating the user has been authenticated, transmit the electronic certificate.

3. The terminal device according to claim 1, wherein the at least one processor further performs operation to:
measure the body or voice of the user operating the terminal device at a timing different from a timing at which the first biological information is acquired, and acquire third biological information, the third biological information being biological information according to a result of the measurement, and
authenticate the user by comparison based on the first biological information and the third biological information.

4. The terminal device according to claim 1, wherein the at least one processor further performs operation to:
transmit the electronic certificate and the authentication result to a server accepting a procedure performed by the user, and
receive implementation status information indicating an implementation status of the procedure based on the electronic certificate and the authentication result that have been transmitted.

5. The terminal device according to claim 1, wherein the at least one processor further performs operation to:
generate document information associated with the procedure, and
transmit the document information when the user is authenticated.

6. The terminal device according to claim 5, wherein the at least one processor further performs operation to:
encrypt the document information,
acquire a private key and a public key relevant to the private key stored in the information storage medium,
encrypt the document information based on the private key, and
when the user is authenticated, transmit the public key and the encrypted document information.

7. The terminal device according to claim 5, wherein the at least one processor further performs operation to:
when the user is not authenticated, temporarily store the generated document information.

8. An identity verification assistance method comprising:
in a terminal operated by a user,
measuring a body or voice of the user when authenticating the user;
acquiring first biological information, the first biological information being biological information according to a result of the measurement;
acquiring second biological information and an electronic certificate indicating authenticity of a person, the second biological information being biological information relevant to a body or voice of the person, the second biological information and the electronic certificate being stored in an information storage medium;
authenticating the user by comparison based on the first biological information and the second biological information; and
transmitting the acquired electronic certificate and an authentication result when the user is authenticated.

9. A non-transitory computer-readable storage medium storing a program for executing a process comprising:
in a terminal operated by a user,
measuring a body or voice of the user when authenticating the user;
acquiring first biological information, the first biological information being biological information according to a result of the measurement;
acquiring second biological information and an electronic certificate indicating authenticity of a person, the second biological information being biological information relevant to a body or voice of the person, and an electronic certificate indicating authenticity of the person, the second biological information and the electronic certificate being stored in an information storage medium;
authenticating the user by comparison based on the first biological information and the second biological information; and
transmitting the acquired electronic certificate and an authentication result when the user is authenticated.
